(19) United States
(12) Patent Application Publication
(10) Pub. No.: US 2026/0347052 A1
(43) Pub. Date: Nov. 5, 2026

(54) Biodegradable Paper Cup Coated with Plant-Derived or Bioengineered Cutin for Enhanced Water Resistance

(71) Applicant: Nikhil Jose, Dallas, TX (US)

(72) Inventor: Nikhil Jose, Dallas, TX (US)

(21) Appl. No.: 19/198,079

(22) Filed: May 4, 2025

(51) Int. Cl. B65D 25/14; B65D 65/46; D21H 19/28

(52) U.S. Cl. CPC B65D 25/14; B65D 65/466; D21H 19/28; B65D 2565/382

(57) ABSTRACT

A biodegradable paper cup coated with cutin, either plant-extracted or bioengineered, providing a plastic-free, water-resistant, and compostable alternative to traditional polyethylene or PLA-lined cups. The cutin is applied via standard coating processes and can withstand hot liquids while enabling full biodegradability. The elimination of synthetic plastic liners reduces the release of microplastics into the environment and minimizes associated health risks.

### FIELD OF THE INVENTION

The present invention relates generally to biodegradable food and beverage containers and, more specifically, to paper cups coated with a hydrophobic layer of cutin, either derived from natural plant sources or bioengineered microbial production, to provide water and heat resistance without reliance on petroleum-based plastics.

### BACKGROUND OF THE INVENTION

Disposable paper cups typically use polyethylene or PLA (polylactic acid) linings to hold liquids. These linings hinder recyclability and biodegradability, contributing to plastic pollution. There is a need for an environmentally friendly, compostable, and scalable water-resistant coating that can be applied to paper-based containers.

Cutin is a natural polyester found in the cuticle of plant leaves and fruit skins. It possesses hydrophobic properties and is biodegradable. Recent advancements in synthetic biology also allow for the production of cutin monomers or analogs using genetically engineered microbes.

Furthermore, there is increasing evidence that microplastics from conventional plastic-lined disposable containers are entering the food chain and being ingested by humans, potentially causing health issues including inflammation, endocrine disruption, and cellular damage. By eliminating synthetic plastic liners and replacing them with plant-based or bioengineered biodegradable coatings, this invention significantly reduces microplastic exposure and its associated health risks.

### SUMMARY OF THE INVENTION

The invention provides a biodegradable paper cup with a thin, durable coating of cutin, applied to the interior surface of the paperboard substrate. The coating may be derived from plant waste or synthesized using engineered microbes. The invention encompasses the method of extracting or producing cutin, applying it to cups, and the resulting product's properties.

This invention aims to reduce microplastic pollution, prevent health risks associated with microplastic ingestion, provide a scalable alternative to plastic linings, and enable full compostability without compromising performance.

### BRIEF DESCRIPTION OF THE DRAWINGS

FIG. 1: Side view of the paper cup showing the cutin coating on the interior wall and base, and the liquid fill inside.

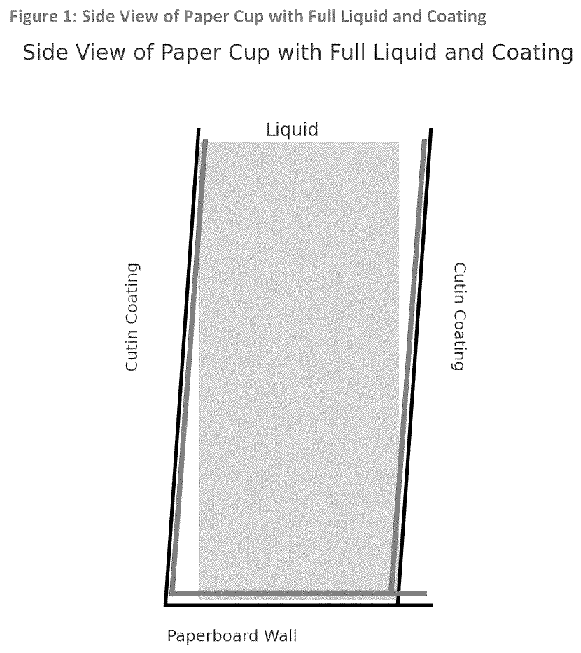

FIG. 2: Flow diagram illustrating the cutin extraction or synthesis process and application steps.

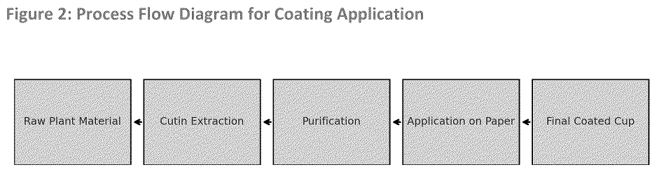

### DETAILED DESCRIPTION OF THE INVENTION

### Materials

Paperboard cup: food-grade, uncoated paper used for forming traditional paper cups.
Cutin: a natural hydrophobic polyester obtained from tomato peels, mango or jackfruit leaves, or alternatively, synthesized via microbial fermentation (e.g., engineered E. coli, Yarrowia lipolytica).

### Methods of Cutin Sourcing

1. Plant Extraction: Plant materials are cleaned, dried, and ground. Cutin is extracted using alkaline hydrolysis, enzymatic digestion, or ethanol-based methods. The extract is purified and concentrated.
2. Bioengineered Production: Genes encoding cutin biosynthetic enzymes are expressed in a microbial host. Fermentation produces cutin monomers, which are polymerized and purified.

### Application

The extracted or synthesized cutin is applied to the interior of the cup by dip coating, spray coating, or thermal deposition. It may be cured or dried at 60-120 °C to enhance film formation. The target thickness is 5-50 microns.

### Properties

Hydrophobic, water-resistant inner surface
Fully biodegradable and compostable
Withstands hot liquids (up to ~100 °C)
May be microwave compatible for short durations
Eliminates plastic-derived microplastic generation, thereby improving public health safety

### Alternative Embodiments

Blends of cutin with other natural biopolymers such as waxes or shellac
Multilayer coating structure for additional grease resistance
Enhanced coatings for industrial compostability or extended shelf life

1. A biodegradable paper cup comprising:
a paperboard substrate; and
a coating of cutin on at least the interior surface of said substrate, wherein said cutin is derived from plant sources or bioengineered microbial synthesis.

2. The paper cup of claim 1, wherein the cutin coating is applied by a process selected from dip coating, spray coating, or thermal deposition.

3. The paper cup of claim 1, wherein the cutin is extracted from tomato peels, mango leaves, jackfruit leaves, or combinations thereof.

4. The paper cup of claim 1, wherein the cutin is synthesized by microbial fermentation using genetically engineered microorganisms.

5. The paper cup of claim 1, wherein the cutin coating has a thickness between 5 and 50 microns.

6. The paper cup of claim 1, wherein the cutin coating renders the cup water-resistant and biodegradable.

7. A method of manufacturing a biodegradable paper cup comprising:
extracting or synthesizing cutin;
applying said cutin to an interior surface of a paperboard cup; and
curing or drying the coated cup to form a hydrophobic layer.

8. The method of claim 7, wherein the cutin is derived from plant waste.

9. The method of claim 7, wherein the cutin is produced by engineered microbes.

10. The method of claim 7, wherein the coated paper cup is compostable and compatible with hot liquids.
